(19) United States
(12) Patent Application Publication
(10) Pub. No.: US 2006/0149873 A1
(43) Pub. Date: Jul. 6, 2006

(54) Bus isolation apparatus and method

(76) Inventors: Brad O. Underwood, Plano, TX (US); Kevin A. Egan, Plano, TX (US); Mark A. Shaw, Sachse, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/028,926

(22) Filed: Jan. 4, 2005

(51) Int. Cl. G06F 13/00

(52) U.S. Cl. 710/104

(57) ABSTRACT

A system includes a bus isolation component having plural ports and enable inputs to enable respective ports, and bus devices connected to respective ports. Each bus device has logic to provide an enable signal to a respective enable input of the bus isolation component. The port of the bus isolation component connected to a respective bus device is disabled until the logic in the respective bus device activates the enable signal to the respective enable input of the bus isolation component.

### BACKGROUND

A computer system typically includes one or more buses to enable communication between devices. The buses include a processor bus or system bus to enable inter-communication among a processor, storage devices, input/output (I/O) devices, peripheral devices, and so forth. In addition, some computer systems include a management bus to enable management-related devices to communicate with each other separately from the processor or system bus.

Typically, management buses, such as an I²C bus, are provided in high-performance computer server systems, storage server systems, or other electronic systems. A management bus enables a management module to perform various types of management tasks, such as monitoring the health of various components of the system, disabling failed components, and so forth. For redundancy, it may be desirable to have multiple management modules that are connected to the management bus. However, a concern associated with connecting multiple management modules to a management bus is that failure of one management module may disable the management bus such that the remaining one or more management modules may not be able to communicate over the management bus. If a failed management module causes failure of the management bus, then the system may not operate properly, particularly when the remaining management module(s) can no longer communicate with certain devices to allow such devices to initialize or reset properly.

### BRIEF DESCRIPTION OF THE DRAWINGS

FIG. 1 is a block diagram of an electronic system that incorporates an embodiment of the invention.

FIG. 2 is a block diagram of bus devices connected to a bus structure according to one embodiment.

FIG. 3 is a flow diagram of a process performed by power-on logic in a bus device, in accordance with an embodiment.

### DETAILED DESCRIPTION

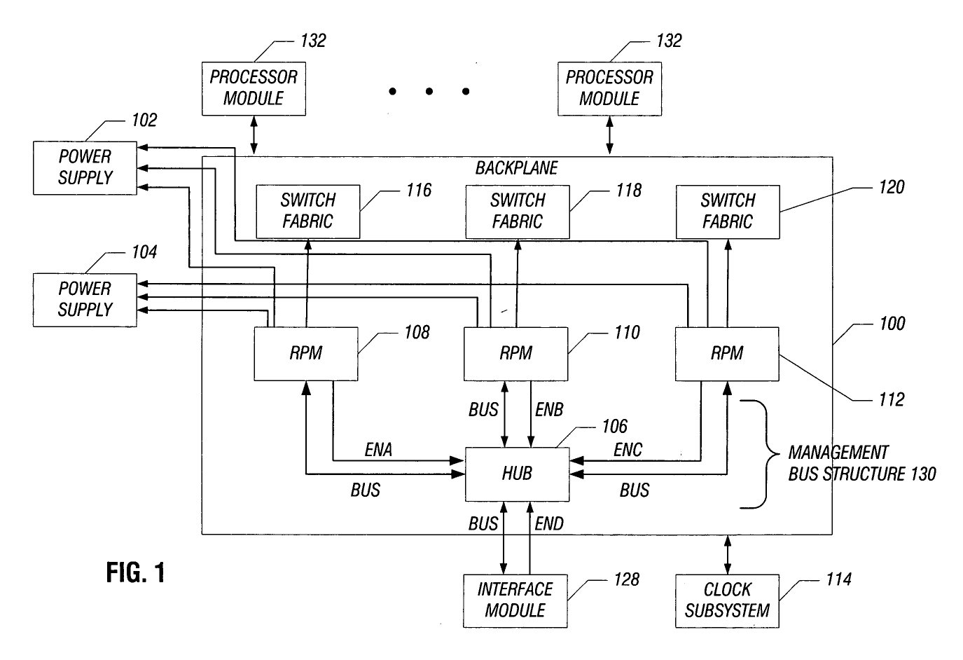

FIG. 1 illustrates an example electronic system that includes a backplane 100, which includes interconnect circuits and components (collectively referred to as “interconnect structures”) for enabling devices of the electronic system to communicate with each other. The electronic system depicted in FIG. 1 is an example of a computer server system that has a plurality of processing modules 132. Each processing module 132 includes one or more central processing units (CPUs) and related devices, such as memory devices, input/output (I/O) control devices, and so forth. Although a computer server system is depicted in FIG. 1, other embodiments of the invention can include other types of electronic systems, such as storage server systems, telecommunication switch systems, and so forth.

The processing modules 132 are able to communicate with each other over the backplane 100. The interconnect structures of the backplane 100 include multiple switch fabrics 116, 118, and 120. Each switch fabric 116, 118, 120 includes one or more switch fabric controllers (not shown). Each switch fabric 116, 118, 120 also includes interconnect circuits (communication lines or buses). Communication over the interconnect circuits are controlled by respective switch fabric controllers.

The electronic system of FIG. 1 also includes multiple power supplies 102 and 104. In other implementations, three or more power supplies can be provided in the electronic system. The switch fabric controllers of the switch fabrics 116, 118, 120 are clocked by clock signals from a clock subsystem 114. Other components of the electronic system include an interface module 128, which enables communication between the electronic system depicted in FIG. 1 and other nodes or systems, such as user systems or other electronic systems. The interface module 128 is able to communicate with redundant reset and power management modules 108, 110, and 112.

According to one embodiment, each of the reset and power management modules 108, 110, 112 performs the following tasks: power supply management; clock subsystem monitoring and reporting; and reset control of the switch fabric controllers. Other or alternative management tasks can be performed by the reset and power management modules 108, 110, 112 in other embodiments. The three reset and power management modules 108, 110, and 112 are redundant modules. If any one or even two of the reset and power management modules should exhibit failure, the electronic system can nevertheless continue to operate due to the presence of the remaining functional one or more reset and power management modules. Although three redundant reset and power management modules are depicted in FIG. 1, it is contemplated that other embodiments can employ two reset and power management modules or more than three reset and power management modules.

Thus, for example, if the reset and power management module 112 should fail, the remaining reset and power management modules 108, 110 can continue to perform management tasks with respect to the switch fabrics 116, 118 and power supplies 102, 104. The remaining reset and power management modules 108, 110 can also continue to perform monitoring of the clock subsystem 114.

The reset and power management modules 108, 110, 112 can be implemented as field programmable gate arrays (FPGAs), application-specific integrated circuits (ASICs), microcontrollers, microprocessors, and so forth.

A feature of the reset and power management modules 108, 110, and 112 is that they are independent of each other and do not rely upon each other for their tasks. No handshaking or other forms of interaction is performed between the reset and power management modules 108, 110, 112. In the event of a failure of any single reset and power management module, corruption of management and reporting tasks of the other reset and power management modules would not occur to enhance the likelihood of continued operation of the electronic system. In accordance with some embodiments, to avoid failure of one reset and power management module from disabling or otherwise corrupting other reset and power management modules, the reset and power management modules 108, 110, and 112 are connected to a management bus structure 130 that includes a hub 106.

The hub 106 is effectively a bus isolation component to isolate defective reset and power management modules connected to the management bus structure 130. The hub 106 has multiple ports that are connected over a respective bus to a respective reset and power management module. In one embodiment, the bus is a serial bus that includes a data line and a clock line. An example of a bus that can be used for management tasks is the I²C bus. One version of the I²C bus is described by the I²C Bus Specification, Version 2.1, dated January 2000. In other embodiments, other types of buses can be used.

Each port of the hub 106 is enabled by a respective enable signal EN (ENA, ENB, ENC, and END depicted in FIG. 1). Thus, the ENA signal is used to enable the port of the hub 106 connected to the reset and power management module 108 over a corresponding bus. The ENB signal enables the port connecting the hub 106 and reset and power management module 110. The ENC signal enables the port connecting the hub 106 and the reset and power management module 112. The END signal enables the port connecting the hub 106 and the interface module 128.

Enabling a port of the hub 106 means that the port allows the connected bus device to communicate over the management bus structure 130. Disabling a port of the hub 106 means that the port is isolated from the management bus structure. The reset and power management modules 108, 110, 112 communicate with the interface module 128 over the management bus structure 130. In turn, the interface module 128 communicates information (such as health information relating to the power supplies, switch fabrics, and/or clock subsystem) received from the reset and power management modules to other devices in the electronic system. Similarly, the interface module 128 can communicate information or commands received from other devices to the reset and power management modules 108, 110, 112.

More generally, the reset and power management modules are examples of “management modules” that perform management tasks (e.g., monitoring health, enabling/disabling, etc.) with respect to devices (e.g., power supplies, interconnect structures, clock subsystems, etc.).

By using the hub 106 according to some embodiments, effective bus isolation is provided in the event of failure of any of the reset and power management modules. A failed reset and power management module would be disabled from communicating over the bus structure 130 and possibly corrupting communications of other reset and power management modules.

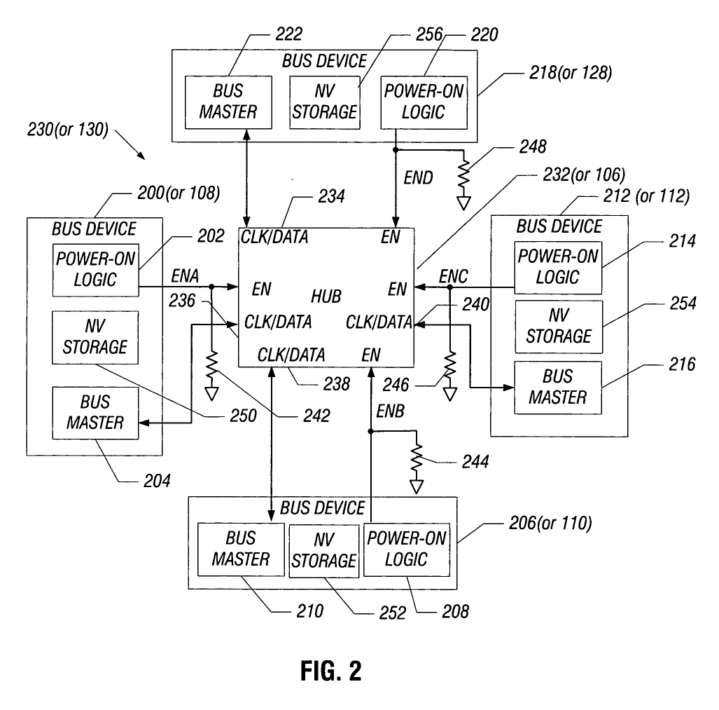

FIG. 2 illustrates a bus structure 230 in greater detail. In one embodiment, the bus structure 230 is the management bus structure 130 of FIG. 1. The bus structure 230 is connected to bus devices 200, 206, 212, and 218. In one embodiment, the bus devices 200, 206, 212, and 218 are the reset and power management modules 108, 110, 112, and interface module 128. Note, however, in other embodiments, the bus devices 200, 206, 212, and 218, and bus structure 230 can be general purpose bus devices and bus structure different from the management modules and management bus structure of FIG. 1. For example, the bus structure 230 can be a bus for enabling communications between processors and other devices, between peripheral devices, and so forth.

The bus device 218 includes bus master logic 222. The bus master logic 222 of the bus device 218 is connected to a port 234 of a hub 232 (which can be the hub 106 of FIG. 1 in one embodiment) that is part of the bus structure 230. In one embodiment, the port 234 communicates clock and data signals with the bus master logic 222 in the bus device 218. One example of the bus connecting the bus master logic 222 and port 234 is a serial bus, such as the I²C bus. In other embodiments, parallel buses can be used instead of a serial bus. The port 234 is enabled by activation of an enable signal END provided by power-on logic 220 in the bus device 218. The END signal is connected to an enable input (EN input) of the hub 232 corresponding to the port 234.

Each of the bus devices 200, 206, and 212 includes respective bus slave logic 204, 210, and 216. The bus slave logic 204 in the bus device 200 is connected to a port 236 of the hub 232. The port 236 is enabled by an ENA signal provided from power-on logic 202 in the bus device 200 to a corresponding enable input of the hub 232. Similarly, the bus slave logic 210 in the bus device 206 is connected to a port 238 of the hub 232. The port 238 is enabled by a power-on logic 208 in the bus device 206 asserting an ENB signal that is provided to a corresponding enable input of the hub 232. A port 240 of the hub 232 is connected to bus slave logic 216 in the bus device 212. The port 240 is enabled by an ENC signal from power-on logic 214 of the bus device 212, which is provided to a corresponding enable input of the hub 232.

During initialization, such as during a power-on sequence or a reset sequence, each of the power-on logic 202, 208, 214, and 220 maintains a respective ENA, ENB, ENC, END signal deactivated such that the respective port 234, 236, 238, and 240 is disabled.

In the embodiment illustrated in FIG. 2, the ENA, ENB, ENC, and END signals are connected by pull-down resistors 242, 244, 246, 248, respectively, to a reference voltage such as ground. Thus, during initialization, each power-on logic 202, 208, 214, and 220 tristates its EN output (that drives a respective one of the ENA, ENB, ENC, END signals) such that the respective pull-down resistor 242, 244, 246, and 248 can pull the respective ENA, ENB, ENC, and END signal to an inactive state. Alternatively, instead of relying on the pull-down resistor, each power-on logic can actively drive the respective enable signal to an inactive state during initialization. In either case, the power-on logic is said to maintain the enable signal inactive (by either tristating its output so that a pull-down resistor can pull the enable signal low, or by actively driving the enable signal low).

Note that reference to pulling down the enable signal is provided for the purpose of example. In different implementations, the inactive state of the enable signal (ENA, ENB, ENC, or END) can be a high state, in which case pull-up resistors are used to pull the enable signal high when the power-on logic tristates its EN output. In other embodiments, other types of pull-up or pull-down devices can be used for inactivating the ENA, ENB, ENC, END signals.

Each bus device 200, 206, 212, and 218 also includes a non-volatile storage 250, 252, 254, 256, respectively. The non-volatile storage can be implemented as an electrically erasable and programmable read-only memory (EEPROM), a flash memory, a battery backed-up random access memory, or other type of non-volatile storage. In another embodiment, instead of using non-volatile storage, volatile storage can be used. The non-volatile storage 250, 252, 254, 256 is used to store configuration information that is transferred to a respective bus device 200, 206, 212, 218 during a configuration stage. The configuration information that is provided for storage in the non-volatile storage 250, 252, 254, 256 includes instructions (program code) that are executable by the bus device 200, 206, 212, 218 during operation of the bus device. The instructions when executed cause the bus device to perform programmed tasks, such as management tasks.

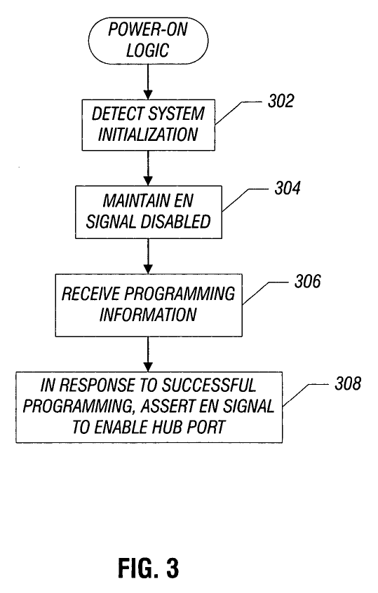

FIG. 3 illustrates a sequence performed by the power-on logic 202, 208, 214, or 220. The power-on logic detects (at 302) system initialization, which occurs during a power-on sequence or during system reset, for example. Upon detection of system initialization, the power-on logic maintains (at 304) the enable signal (ENA, ENB, ENC, or END of FIG. 2) disabled (by either tristating its output such that a pull-down resistor can pull the signal inactive, or by actively driving the enable signal to an inactive state). The bus device then receives (at 306) configuration information (e.g., program code) to program the bus device. A bus device is “programmed” if the bus device receives and stores configuration information, such as program code, to enable the bus device to perform management or other predefined tasks. In response to successful programming, the power-on logic asserts (at 308) the respective enable signal to enable the respective hub port.

However, if successful programming cannot be performed, such as due to a defect or other failure of the bus device, the power-on logic does not change the state of its EN output. In other words, the power-on logic either maintains its EN output tristated (to enable an external pull-down resistor to pull the respective enable signal to an inactive state), or the power-on logic drives its EN output to the inactive state. Driving the enable signal to the inactive state effectively disables the corresponding port at the hub 232 (FIG. 2), such that the failed bus device stays off the bus structure 230. The hub 232 effectively isolates the failed bus device from the bus structure 230, such that the failed bus device does not disable or otherwise corrupt the remaining bus devices connected to the bus structure 230. Consequently, the remaining bus devices can continue to communicate over the bus structure 230, such as to perform the management-related tasks associated with the reset and power management modules of FIG. 1.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. An apparatus comprising:
a bus isolation component having a plurality of ports and a plurality of enable inputs to enable the respective ports; and
a plurality of bus devices connected to the respective ports, each of the bus devices having logic to provide one of plural enable signals to a respective one of the enable inputs of the bus isolation component,
wherein one of the ports of the bus isolation component connected to one of the respective bus devices is disabled until the logic in the respective one of the bus devices activates the enable signal to the respective one of the enable inputs of the bus isolation component.

2. The apparatus of claim 1, further comprising buses connected between the bus devices and the respective ports of the bus isolation component.

3. The apparatus of claim 2, wherein the buses comprise I 2C buses.

4. The apparatus of claim 1, wherein the bus isolation component has a first port and a second port of the ports and respective first and second enable inputs of the enable inputs,
wherein the bus devices comprise a first bus device connected to the first port, and a second bus device connected to the second port, the logic of the first bus device to provide a first one of the enable signals to the first enable input, and the logic of the second bus device to provide a second one of the enable signals to the second enable input.

5. The apparatus of claim 1, wherein the logic of each of the bus devices maintains the respective one of the enable signals inactive until the bus device has been programmed.

6. The apparatus of claim 5, wherein the logic of each of the bus devices maintains the respective one of the enable signals inactive during at least one of a boot sequence of the system and reset of the system.

7. The apparatus of claim 6; wherein the logic of each of the bus devices activates the respective one of the enable signals in response to detecting that the bus device has been programmed with configuration information to enable the bus device to perform predefined tasks, wherein activating the respective one of the enable signals causes enabling of the respective one of the ports of the bus isolation component to enable communication of the respective bus device with a bus structure.

8. The apparatus of claim 5, wherein the logic of each of the bus devices maintains the respective one of the enable signals inactive during system initialization.

9. The apparatus of claim 1, wherein the bus isolation component comprises a hub having the plurality of ports and the plurality of enable inputs.

10. The apparatus of claim 1, wherein a first one of the bus devices contains bus master logic, and the remaining bus devices contain bus slave logic.

11. The apparatus of claim 1, wherein the logic of each of the bus devices maintains the respective enable signal inactive to disable the respective port of the bus isolation component until the bus device has been loaded with instructions to enable the bus device to perform programmed tasks.

12. The apparatus of claim 11, wherein each of the bus devices includes a storage to store the instructions.

13. The apparatus of claim 12, wherein the storage of each of the bus devices comprises non-volatile storage.

14. The apparatus of claim 1, further comprising at least one power supply, wherein at least two of the bus devices comprise management modules to manage the at least one power supply.

15. The apparatus of claim 1, further comprising electronic modules and interconnect structures to enable communication between the electronic modules, wherein the management modules control reset of the interconnect structures.

16. A method of isolating bus devices connected to a bus structure, comprising:
connecting the bus devices to ports of a bus isolation component, the bus isolation component further having enable inputs to enable the respective ports;
each of the bus devices providing a respective one of plural enable signals to a respective one of the enable inputs of the bus isolation component; and
each of the bus devices maintaining the respective one of plural enable signals to the respective one of the enable inputs of the bus isolation component inactive during system initialization to disable the respective one of the ports of the bus isolation component.

17. The method of claim 16, further comprising each of the bus devices activating the respective one of the enable signals after system initialization to enable the respective one of the ports of the bus isolation component.

18. The method of claim 17, further comprising providing a bus structure including the bus isolation component, wherein enabling one of the ports of the bus isolation component enables the corresponding one of the bus devices to communicate over the bus structure.

19. The method of claim 17, wherein each of the bus devices activating the respective one of the enable signals is in response to the bus device being programmed with instructions to enable the bus device to perform programmed tasks.

20. The method of claim 19, wherein activating the respective one of the enable signals to activate the respective one of the ports is in response to the respective one of the bus devices being successfully programmed.

21. The method of claim 16, further comprising connecting the bus devices to respective ports of the bus isolation component with buses, wherein the buses comprise I²C buses.

22. The method of claim 16, wherein at least two of the bus devices comprise management modules, wherein the system comprises power supplies, the method further comprising the management modules managing the power supplies.

23. A system, comprising:
management modules to manage components of the system; and
a bus structure comprising an isolation component, the management modules to communicate over the bus structure, and the isolation component having a plurality of ports,
each of the management modules connected to a respective one of the ports of the isolation component, and
each of the management modules having logic to provide one of plural enable signals that when activated enables a respective one of the ports.

24. The system of claim 23, wherein the system comprises power supplies, and wherein the management modules are adapted to manage the power supplies.

25. The system of claim 24, wherein the system comprises a clock subsystem, and wherein at least one of the management modules is adapted to monitor health of the clock subsystem.

26. The system of claim 23, wherein each of the management modules includes a storage, the logic in each of the management modules to activate the respective one of the enable signals in response to the storage being programmed with predetermined configuration information.

27. The system of claim 26, further comprising I²C buses connecting the management modules to the respective ports of the isolation component.

28. The system of claim 26, wherein the logic in each of the management modules is adapted to maintain the respective one of the enable signals inactive during system initialization until the storage is programmed with the predetermined configuration information.

29. An apparatus comprising:
a plurality of bus devices; and
means for isolating the plurality of bus devices, the means for isolating having a plurality of ports and a plurality of enable inputs to enable the respective ports,
wherein the plurality of bus devices are connected to the respective ports, each of the bus devices having means for providing one of plural enable signals to a respective one of the enable inputs of the means for isolating,
wherein one of the ports of the means for isolating is disabled until the means for providing one of plural enable signals in the respective one of the bus devices activates the enable signal to the respective one of the enable inputs of the means for isolating.

30. The apparatus of claim 29, wherein the means for providing one of the enable signals of each of the bus devices maintains the one of the enable signals inactive until the bus device has been programmed.

31. The apparatus of claim 30, wherein the means for providing one of the enable signals of each of the bus devices activates the respective one of the enable signals in response to successful programming of the respective one of the bus devices.
